(19) United States
(12) Patent Application Publication
(10) Pub. No.: US 2020/0180752 A1
(43) Pub. Date: Jun. 11, 2020

(54) METHOD FOR SPEED CONTROL OF AN AIRCRAFT WHEEL ROTATION DRIVE DEVICE

(71) Applicant: SAFRAN LANDING SYSTEMS, Velizy Villacoublay (FR)

(72) Inventor: Laurent BOISSARD, MOISSY-CRAMAYEL (FR)

(73) Assignee: SAFRAN LANDING SYSTEMS, Velizy Villacoublay (FR)

(21) Appl. No.: 16/702,740

(22) Filed: Dec. 4, 2019

(30) Foreign Application Priority Data
Dec. 5, 2018 (FR) 18 72387

(51) Int. Cl. B64C 25/40; B64C 25/34

(52) U.S. Cl. CPC B64C 25/405; B64C 25/34

(57) ABSTRACT

A method of speed control of a wheel rotation drive device carried by aircraft landing gears, comprising the step of regulating an aircraft speed in accordance with a pilot-generated speed command, wherein the speed of the regulated aircraft is a speed (V̅) measured or estimated at a nose tip of the aircraft

The invention relates to a method for speed control of a device for driving the wheels of an aircraft in rotation.

### BACKGROUND OF THE INVENTION

Aircraft wheel rotation drive devices that can move the aircraft on the ground without the assistance of its power trains are known. The drive device includes drive actuators adapted to drive aircraft wheels in rotation when placed in the wheel engagement position. On an aircraft with two main landing gears, such as the AIRBUS A320, for instance, drive devices have been proposed with at least one drive actuator on each of the main landing gears adapted to drive at least one wheel in rotation. Various control strategies for these drive devices have been proposed, including strategies to control an aircraft speed to a pilot-generated speed setpoint.

Such servo-control requires measuring the speed of the aircraft, or at least making an estimate thereof. For example, the speed measurement given by the inertial unit of the aircraft, a speed estimate given by an on-board GPS, or an average of the circumferential speeds of the wheels driven by the actuators of the drive device can be used, these speeds being deduced directly from the rotational speed of the engines of the drive actuators or from the rotational speed of the driven wheels. The estimated speed is substantially the same as that of the centre of gravity of the aircraft.

Tests have shown that under certain circumstances, such as during turns, aircraft pilots may feel that they are experiencing much higher speeds than the set speed.

### PURPOSE OF THE INVENTION

The invention aims to propose a method of speed control of a device that drives the wheels of an aircraft in rotation, reducing the feeling of runaway felt by pilots during turns.

### SUMMARY OF THE INVENTION

To achieve this goal, a method of speed control of an aircraft wheel rotation drive device is proposed, comprising the step of regulating an aircraft speed in accordance with a pilot-generated speed command, wherein the speed of the regulated aircraft is a measured or estimated speed of a portion of the aircraft located at a nose tip of the aircraft.

Thus, during turns, the speed at the nose tip of the aircraft, which is typically several metres from the centre of gravity of the aircraft, is more representative of the speed perceived by pilots than the speed at the centre of gravity of the aircraft. Pilots no longer have the impression of speed runaway when turning.

A preferred embodiment is to estimate the speed to be regulated as an estimate of a circumferential wheel speed of an auxiliary landing gear of the aircraft located under the nose tip of the aircraft.

### BRIEF DESCRIPTION OF THE DRAWINGS

The invention will be better understood upon reading the following description of one specific embodiment of the invention, while referring to the appended figures, wherein:

FIG. 1 is a schematic view showing the trajectory of a centre of gravity of an aircraft and the trajectory followed by the wheels of the auxiliary landing gear;

FIG. 2 is a schematic top view of an aircraft showing the various quantities used to estimate the longitudinal velocity at the wheels of the auxiliary landing gear.

### DETAILED DESCRIPTION OF THE INVENTION

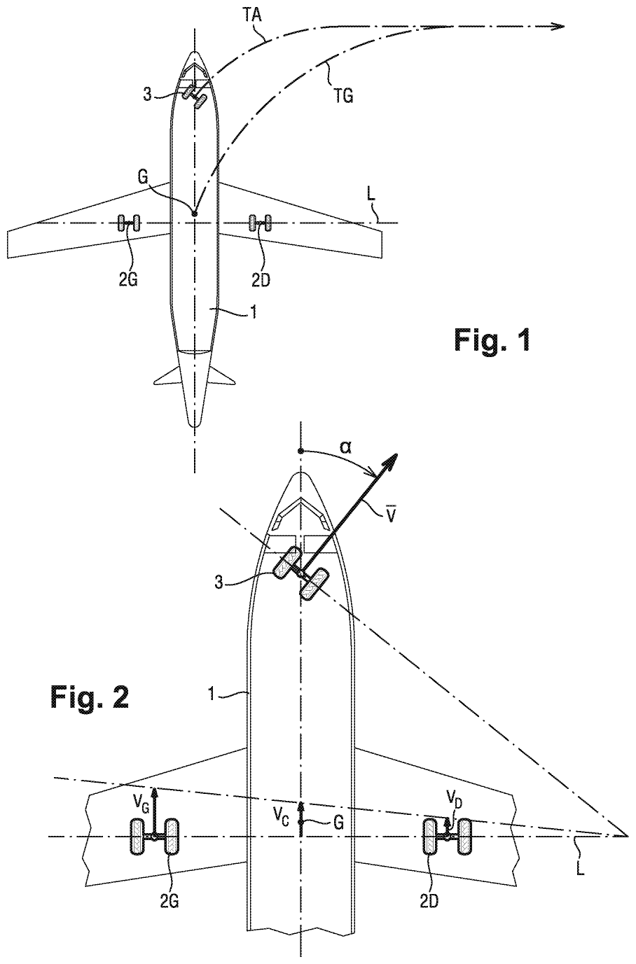

FIG. 1 shows an aircraft 1 making a right turn. The aircraft is equipped with a left main landing gear 2G and a right main landing gear 2D, and an auxiliary landing gear 3 located at a nose tip 4 of the aircraft. It should be noted that the auxiliary landing gear is located substantially at the level of the aircraft cockpit. On an AIRBUS A320 aircraft, the cockpit and auxiliary landing gear are at least ten metres from an imaginary line L passing through the main landing gear 2G, 2D. The centre of gravity G of the aircraft is slightly in front of the imaginary line L. Here, the main landing gears 2G, 2D are equipped with a rotating wheel drive system, with a rotating drive actuator (e. g. outer wheels) on each main landing gear. A servocontrol is used to regulate an aircraft speed to a speed setpoint generated by the pilot, for example by means of a joystick in the cockpit. The drive device and the type of speed control used are not the subject of the invention, and can be of any type. For example, a proportional/integral/derived coefficient feedback loop drive can be used.

The trajectory TG of the centre of gravity G, as well as the trajectory TA of the auxiliary landing gear 3, are illustrated during a turn. It can be seen that these trajectories are quite different, generating significant differences in speed along these two trajectories. If the speed of the centre of gravity of the aircraft is controlled by the speed setpoint or the speed of a point close to said centre of gravity, such as the intersection of the longitudinal axis of the aircraft with the imaginary line L, for example, the pilots, who are located in the nose of the aircraft, therefore substantially at the auxiliary landing gear level 3, will have the impression that the speed of the aircraft is running off, particularly during turns.

The purpose of the invention is to reduce this sensation and to do so, it proposes to control to a speed setpoint generated by the pilot not a speed at the centre of gravity level, but a speed at the nose tip of the aircraft. To do this, and depending on a preferred embodiment, an estimated speed V̅ at the auxiliary landing gear 3 is estimated, and it is this speed that the servocontrol will regulate in accordance with the set speed.

According to a first particular embodiment, the speed to be regulated V̅ is estimated by the relationship:

$$\overline{V} = \frac{{v}_{c}}{cos α}$$

Where α is the steering angle of the wheels of the auxiliary landing gear, and V_{c} is the longitudinal speed:

$${V}_{c} = \frac{{V}_{G} + {V}_{D}}{2}$$

The speeds V_{G},V_{D} are the circumferential speeds of a left main landing gear wheel 2G and a right main landing gear wheel 2D respectively (e. g. the outer wheels of the two main landing gears, or the inner wheels of the two main landing gears). V_{c} represents the speed of a point at the intersection of the longitudinal axis and the imaginary line L. Speeds V_{G},V_{D} are estimated, for example, from the rotational speed of the driven wheels, which can be measured by tachometers on the main landing gears, or from the rotational speed of the motor of the drive device actuators. The angle of orientation α of the wheels of the auxiliary landing gear is measured by an angle sensor installed on the auxiliary landing gear.

Thus, the speed to be regulated V̅ can only be estimated by measurements made at the wheels, the actuators of the drive system, or by sensors on the landing gears proper, i.e. only by means of landing gear equipment, thus avoiding any exchange of information with the flight control systems of the aircraft to estimate the speed to be regulated V̅.

A second specific embodiment estimates the angle of orientation of the α wheels of the auxiliary landing gear using the yaw γ rate of the aircraft (i.e. the angular velocity of the aircraft about a vertical axis), provided for example by the inertial unit of the aircraft:

$$\tilde{α} = arctan ( \frac{\dot{γ} \cdot {L}_{x}}{{V}_{C}} )$$

Lₓ is the distance (measured longitudinally) between the imaginary line L and the auxiliary landing gear 3. The speed to be regulated is then estimated by:

$$\overline{V} = \frac{{V}_{C}}{cos \tilde{α}}$$

The invention is not limited to what has just been described, but encompasses every alternative solution within the scope of the claims.

In particular, although the speed at the nose tip of the aircraft being controlled is the speed V̅ measured or estimated directly at the auxiliary landing gear, any other speed may be used, as long as it measures a speed characteristic of a portion of the aircraft extending at the nose tip. For example, it could be directly established by means of accelerometers located in the nose tip of the aircraft, or estimated from data from the inertial unit of the aircraft.

1. A method of speed control of a wheel rotation drive device carried by main landing gears of an aircraft, comprising the step of regulating an aircraft speed in accordance with a speed command generated by the pilot, characterized in that the speed of the regulated aircraft is an estimated speed (V̅) of a portion of the aircraft at a nose tip of the aircraft by means of measurements made at the wheels carried by the main landing gears of the drive device, or by sensors on the main landing gears.

2. A method according to claim 1, wherein the speed (V̅) to be regulated is estimated by means of circumferential speeds (V_{G},V_{D}) of the wheels carried respectively by a left main landing gear and a right main landing gear, and a steering angle (α) of the wheels carried by an auxiliary landing gear arranged at the nose tip of the aircraft, by
$$\overline{V} = \frac{{V}_{C}}{cos α}$$
where:
$${V}_{C} = \frac{{V}_{G} + {V}_{D}}{2}$$

3. A method according to claim 1, wherein the speed (V̅) to be regulated is estimated by means of circumferential speeds (V_{G},V_{D}) of the wheels carried respectively by a left main landing gear and a right main landing gear, and a yaw rate (γ) of the aircraft, by
$$\overline{V} = \frac{{V}_{C}}{cos \tilde{α}}$$
where:
$$\begin{matrix}{V}_{C} = \frac{{V}_{G} + {V}_{D}}{2} & \\ and & \\ \tilde{α} = arctan ( \frac{\dot{γ} \cdot {L}_{x}}{{V}_{C}} ) & \end{matrix}$$
Where Lₓ is a distance (measured longitudinally) between an imaginary line (L) passing through the main landing gears (2G,2D) and the auxiliary landing gear (3).
